(19) United States
(12) Patent Application Publication
(10) Pub. No.: US 2002/0095456 A1
(43) Pub. Date: Jul. 18, 2002

(54) System and computer program for managing information on individuals

(76) Inventor: Li Wensheng, Chiba (JP)

Correspondence Address: LAHIVE & COCKFIELD, 28 STATE STREET, BOSTON, MA, 02109, US

(21) Appl. No.: 09/905,354

(22) Filed: Jul. 13, 2001

(30) Foreign Application Priority Data
Jul. 13, 2000 (JP) 2000-212218
Mar. 12, 2001 (JP) 2001-068522

(51) Int. Cl. G06F 15/16; G06F 17/00

(52) U.S. Cl. 709/203; 707/104.1

(57) ABSTRACT

The system according to the invention includes a member database for storing identification codes for a plurality of members and information on respective members and a web server connected to the member database. URLs of the identification code may be printed on a business card of a member. The web server is configured to transmit to a user, in response to access from the user via the Internet, an HTML document that has an input field for the identification code. In response to receipt of the identification code from the user, it searches the database with the identification code as a key to retrieve information on a member corresponding to the identification code, and transmits the information to the user.

### BACKGROUND OF THE INVENTION

1. Field of the Invention

The present invention relates to a system for managing information using the Internet, and more particularly to a system for managing such information via name data.

2. Description of the Prior Art

In business and other social activities, electronic communication among individuals using personal computers, information terminal devices, mobile telephones and similar equipment has been become more and more popular. Business cards are widely utilized as means for effectively communicating address, place of employment, telephone number, e-mail address and other data of the individuals. People exchange a large number of business cards in a day depending on types of their businesses, and a single person may distribute some hundred, a thousand or even more business cards in a year and receive a similar number of business cards. As means for each individual to manage data on many related persons including data obtained from such business cards, an address book and a business card holder of an album type have been used. These means, however, have disadvantages in that updating and editing of such data is troublesome and it cannot be electronically retrieved.

In order to utilize a search function, it is necessary to convert business card information into an electronic file and build a database. For this purpose, it has been proposed to read a business card using an OCR function and electronically store its information in a database. This approach has many disadvantages in that characters may be incorrectly read due to small characters used in a business card. In addition, such a database is nothing more than a simple address book.

Accordingly, there is a need for a system and a program that enables a unitary arrangement and utilization of information on many individuals.

### SUMMARY OF THE INVENTION

In one aspect, the invention provides a system comprising a database for storing identification codes of a plurality of members as well as information on respective members, and a web server that can communicate with the member database. The web server, in response to access from a user via the Internet, transmits to the user an HTML document that has an input field for entering identification of a person to be searched. In response to transmission of the identification from the user, it searches the database using the identification as a key to retrieve information on the member with matching identification, and transmits the information to the user. Such identification may be made in terms of a unique identification code.

According to the invention, a user can access a URL that are printed on a business card and download information on a member and to its personal computer, mobile telephone, PDA (personal digital assistant) or similar equipment. Thus, the user can obtain an electronic file of the information on the member from the web site.

In addition, in the system according to another aspect of the invention, the web server provides a database program for use by a ser for managing name data. The web server is programmed to transmit to a user, in response to access of the user, an HTML document that includes a button or an input field for requesting downloading of the database program, and responsive to receipt of the request from the user, transmit the database program to the user.

In the system according to another aspect of the invention, the web server comprises a database for producing business cards, and is configured to transmit to a user, in response to access from a user, an HTML document that present a page including a template and input fields for producing business cards, and in response to an input from the user, accept an order for printing business cards.

Moreover, in the system according to another aspect of the invention, the web server includes a recording means for recording an e-mail address of a user who has downloaded information on a member. When a change is made to data on the member, the system transmits by e-mail such change to the user who has downloaded the information on the member.

In another aspect, the invention provides a computer executable program that is adapted for use in conjunction with a system that comprises a member database for storing identification codes of a plurality of members and data on respective members and a web server that communicates with the member database. The web server is configured to search the member database in response to a user access via the Internet to retrieve data on a member, and transmits retrieved data to the user. The computer program has a function of storing the data on the member that is downloaded from the web server in an address book, a function of displaying on a screen of a computer an input page having a text block for preparing a message writing part of a post card or other cards and a picture block for pasting an image, and a function of setting a destination of a post card based on data in the address book.

In one embodiment of the invention, the computer program is transmitted from the web server to a user in response to a user request, and is configured so that name and address data in a CSV format can be imported into the address book or exported therefrom.

In addition, in another embodiment of the invention, the program has a function of transmitting, by clicking a transmission button, a post card or a card of other kinds to a destination by e-mail in the form of the HTML format in which the front side and the back side of the card are arranged horizontally or vertically in one plane.

In addition, in another embodiment of the invention, the system is capable of storing a history of change in the member data. Such change takes place when a member updates its address, for example, registered with the system. Such change can be searched using the identification code as a search key.

In addition, in another embodiment of the invention, the system has a function of retrieving the member information stored in the database in response to a request of a user, and displaying the member information on a browser with a specific layout in the form of the HTML file.

### BRIEF DESCRIPTION OF THE DRAWINGS

These and other objects, features and advantages of the invention will be more apparent from the following detailed description of preferred embodiments taken in conjunction with the accompanying drawings, in which like reference numbers represent like parts of the invention, and in which:

FIG. 1 is a block diagram showing an overall configuration of a system according to an embodiment of the invention;

FIG. 2 is an illustration showing an example of a configuration of a top page of a home page in a system according to an embodiment of the invention;

FIG. 3 is a flow chart showing a process of on-line business card printing;

FIG. 4 is an illustration showing an example of a page for selecting a business card template to be used in the process of on-line business card printing;

FIG. 5 is an illustration showing an example of a page for producing an on-line business card in an embodiment of the invention;

FIG. 6 is a block diagram showing a function of a program for utilizing data in an embodiment of the invention;

FIG. 7 is a flow chart showing a process of producing a postcard in an embodiment of the invention;

FIG. 8 is an illustration showing an example of a page for editing a side of a postcard on which an message is written in an embodiment of the invention; and

FIG. 9 is an illustration showing an example of a page for setting a sender and a destination of a postcard in an embodiment of the invention.

### DETAILED DESCRIPTION OF THE PREFERRED EMBODIMENTS

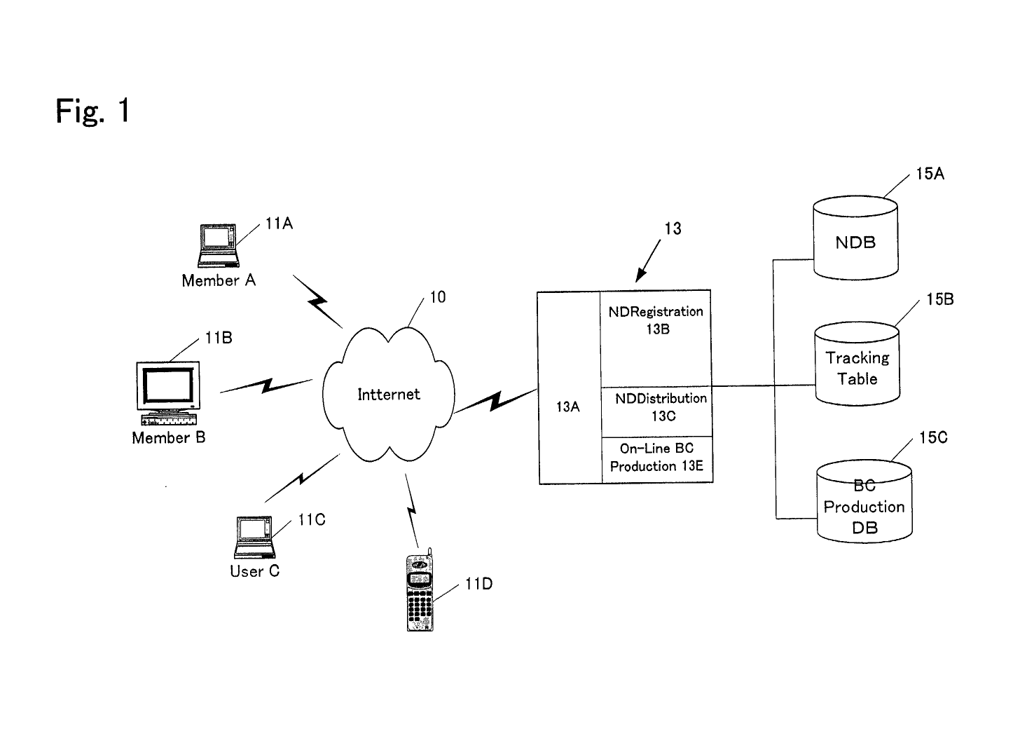

Embodiments of the invention will now be described with reference to the drawings. FIG. 1 is a block diagram showing an overall configuration of an information managing system according to the invention. A web server 13 may be connected via the Internet 10 to any personal computer, mobile telephone that is connectible to Internet or a portable information terminal (PDA; personal digital assistant). A member A can make connection to the web server 13 by starting up a browser on a personal computer 11A and entering a URL address of the web server 13. The browser is a program for performing Internet communication and typically includes Internet Explorer (trademark) of Microsoft Corporation and Netscape Navigator (trademark) of Netscape Communications Corporation.

The web server 13 comprises a communication control section 13A, an ND (name data) registration section 13B for performing a function of registering data (name data) on members to a database 15A, an ND distribution section 13C for distributing data on members to users, and an on-line business card production section 13E for producing business cards in response to requests from the members. Physically, the web server 13 is a general-purpose computer system. Computer programs implement the ND registration section 13B, the ND distribution section 13C and the on-line business card producing section 13E. The communication control section 13A has a function of controlling communications via the Internet 10. It comprises a communication unit that uses the HTTP protocol, and a CGI (Common Gateway Interface) program for producing an HTML document used in communication and for handling transmission from users. The CGI program is typically written in the JavaScript, or may be written in the C language or another language.

A database 15A for name data, a tracking table 15B and a business card producing database 15C are constructed with a database program of Oracle Corporation in this embodiment.

In this document, a person who registers its data in this system and is given an ID with the system is referred to as a member, and a person who accesses this system is referred to as a user. Therefore, a member is also a user of this system in most cases, but a user is not necessarily a member.

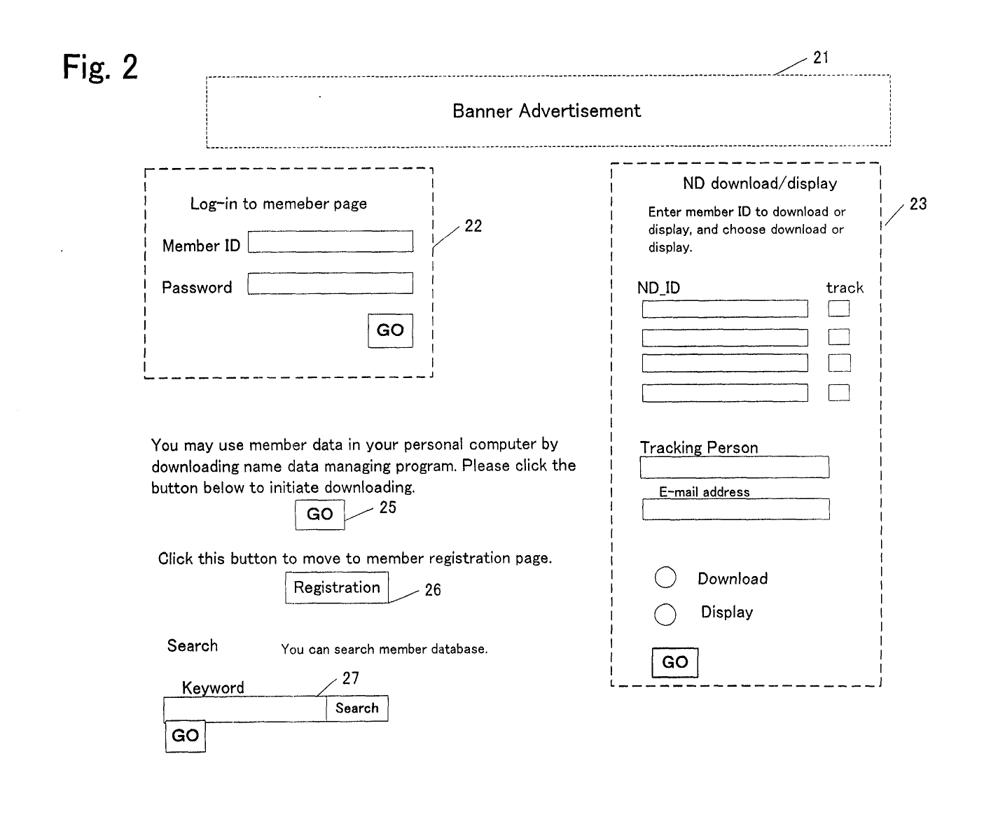

FIG. 2 illustrates in a block diagram an example of a top page displayed on a browser when a user starts the browser from personal computer 11A and accesses a home page of the information managing system according to this invention.

The top page is formed of an HTML document, and an image file of a banner advertisement 21 is embedded in the HTML document using a conventional in-line image function. The HTML document is essentially a text document, and an image included in such a document is identified by an address called URL of the file of the image in the text form using anchor tags.

When personal computer 11A receives the HTML document, the browser executes the HTML document, sends a GET command to the web server 13, and requests transfer of the image file that is identified by the embedded URL. The GCI program of the web server 13 responds to this request to retrieve the image file at the URL in a storage device of the web server 13, and transmit the image file to personal computer 11A. The browser of the personal computer 11A responds to the receipt of this file by displaying the image at a position specified by the HTML document. In this way, an image of the banner advertisement 21 is displayed on the browser. Other graphics and images are displayed on the browser through similar processes.

In the top page shown in FIG. 2, an input section 22 is for logging in to a member page. An input section 23 is for a user to download name data. A button 25 is for a user to download a name data managing program for making use of the name data. A button 26 is hyper-linked to a registration page for a user to register itself as a member. An input section 27 is for a user to search the name data.

A page to which a user can input text is called a form, and an HTML document of a form is typically written with JavaScript. Such an HTML document and a CGI program for handling HTML document can be produce by designing a page to be displayed on the browser and entrusting its production work to a software house. Therefore, only pages on the browser are shown and illustrations of the HTML document and the CGI program are not described herein.

Registration of a Member

A person who wishes to be registered as a member with the information managing system of this embodiment can click a button 26 on the home page of this system shown in FIG. 2 to move to a page for member registration. The page for member registration is configured so that a person wishing to be a member may enter basic information on itself.

When the basic information on a user is entered and transmitted to the web server 13, the name data registration section 13B performs formality check and, if there is no error, issues a member ID to return it to the personal computer 11A. In an embodiment, this member ID is communicated to an applicant by electronic mail after the application for admission is accepted. In another embodiment, a temporary password and a member ID are notified to a user. The member can log in to the member page using the member ID and the temporary password and change the password.

When the member enters its name data on the member page and transmits it to the web server, the web server issues name data ID (ND_ID) corresponding to the name data and communicates the name data ID to the member. A member can register a plurality of kinds of name data and obtain a plurality of ND₁₃ IDs. For example, a member can register name data for a business card for business use and name data for a visiting card for private use, and can obtain separate ND_IDs.

In addition to such a procedure for an individual admission, a major user such as a corporation can register business card data on its employees collectively in this system. More specifically, data on a large number of employees can be entered in a database from a personal computer for system management. In addition, a corporation may provide name data on its employees in the form of an electronic file, which may be imported into the database.

A member wishing to change once registered data may log in to the member page and push a button (not shown) that links to a page for changing member data, which displays an input page for changing data on the browser. Presently registered data is displayed on this page. The displayed data fields are formed as writable fields, so that the data can be revised by overwriting the displayed data.

Member Database

The data on a member who has completed the procedures for admission is stored in the member database 15A. In the member database 16A, one record is prepared for each ND_ID, and a record has fields shown in the following table.

Table 1

Name

ND_ID

Home address

Home telephone number

Home facsimile number

Place of employment

Address of place of employment

Business telephone number

Business facsimile number

E-mail address

URL

Hobbies

Clubs or other organizations

Image

Voice

Comment

Family information

Disclosure level

Printing of ND ID on a business card

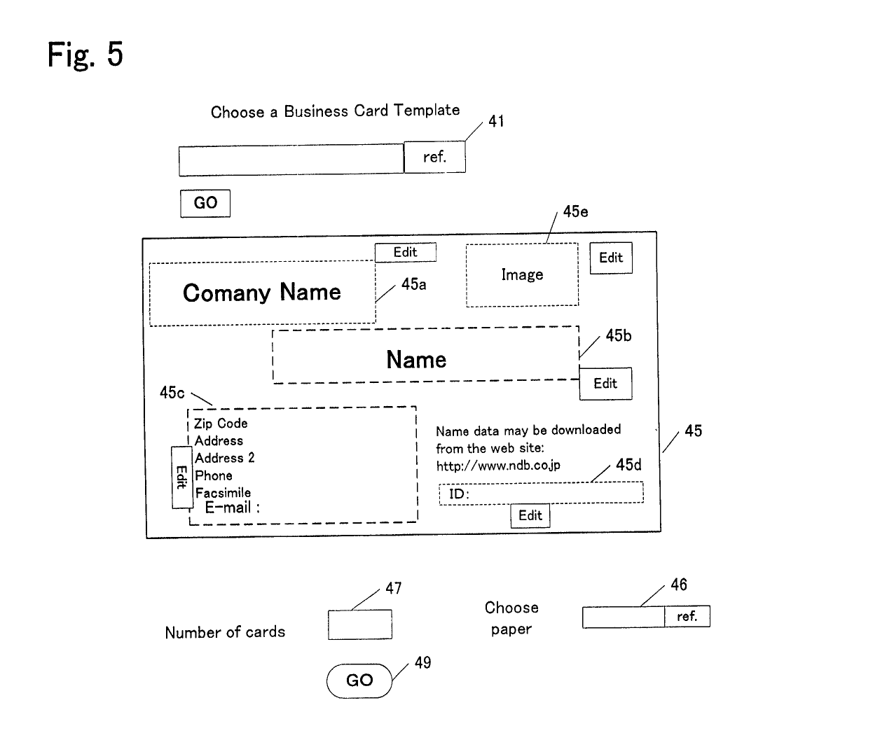

A member can print a URL of the web server 13 and its ND_ID on its own business card. FIG. 5 shows a template that is used in on-line business card production to be described later. In the lower right part of the template, a URL of the web server 13 is displayed. The ND_ID is printed at a position of 45d in FIG. 5.

Downloading and Displaying of Name Data

A person having received a business card from a member may access a home page indicated in the business card and download or display data on the member in its personal computer or mobile telephone connectable to Internet.

Referring to a top page shown in FIG. 2, a user may enter an ND_ID of a member, whose information the user wishes to download or display, in an ID field of a section 23. The user may enter its e-mail address and name in an e-mail address field and a name field. It may select download or display by clicking the word “download” or “display” under the name field, and clicks a GO button beneath it. The name data distribution section 13C of the web server 13 responds to this by searching the member database 15A with the ND_ID transmitted from the user as a key and retrieves data on a corresponding member. When “download” is chosen, a file of name data is transmitted to the user with the HTTP protocol. When “display” is chosen, the name data is transmitted to a browser in the form of an HTML document and displayed on the browser.

Prior to downloading such data on a member, the user can click a button 25 on the top page and download a program for making use of the data on the member. The program can be used to make use of the data downloaded from the web site in the form of an electronic address book.

The user can also import the received data into a spreadsheet program such as Excel program of Microsoft Corporation or a database program such as Access of the company to utilize the data, instead of the program downloaded from the web site.

When the user enters a search keyword in a search field 27 of the top page (FIG. 2) and clicks the GO button, the name data distribution section 13C of the web server 13 responds by searching the member database 15A with the keyword transmitted from the user used as a search key. It transmits retrieved data to the user. The transmitted data is displayed on the browser of the user. When downloading of the displayed data is desired, the user can download the data by selecting download from the menu of the browser and specifying a destination folder for downloading.

Tracking Table

When downloading data on a member, the user can select tracking of data by clicking a tracking box disposed next to the ND_ID in the section 23 of the top page. When this is done, the name data distribution section 13C records e-mail addresses and names of the users who want tracking information in a tracking table 15B in association with the identification of the members to be tracked. The table 15B takes a form as shown in the following table.

TABLE 2

| | | Name of | |
|---|---|---|---|
| Member ID | ND ID | tracking users | E-Mail address |
| jnd00321 | we1234 | XXXXX | xxxxxxxxxx |
| | | YYYYY | yyyyyyyyyy |
| | wr4567 | ZZZZZ | zzzzzzzzzz |
| jnd00345 | ty0987 | AAAAA | aaaaaaaaaa |

When a member changes its data with the above-mentioned process, the name data registration section 13B responds by checking if an ND_ID of the member exists in the tracking table 15B, and if so, transmits changed data on the member to the e-mail addresses recorded in the table. In an embodiment, the transmission of the changed data is performed in such a manner that a file including all open data on the member is transmitted in the form of a file attached to e-mail. A receiving user may overwrite, i.e., replaces an old file with the new file.

A member can view its own tracking table by entering into the member page from a log-in section on a member page 22 as shown in FIG. 2 and selecting the tracking table from the menu. If undesirable persons are included in the tracking table, the member can delete such persons from the table.

On-line Business Card Printing

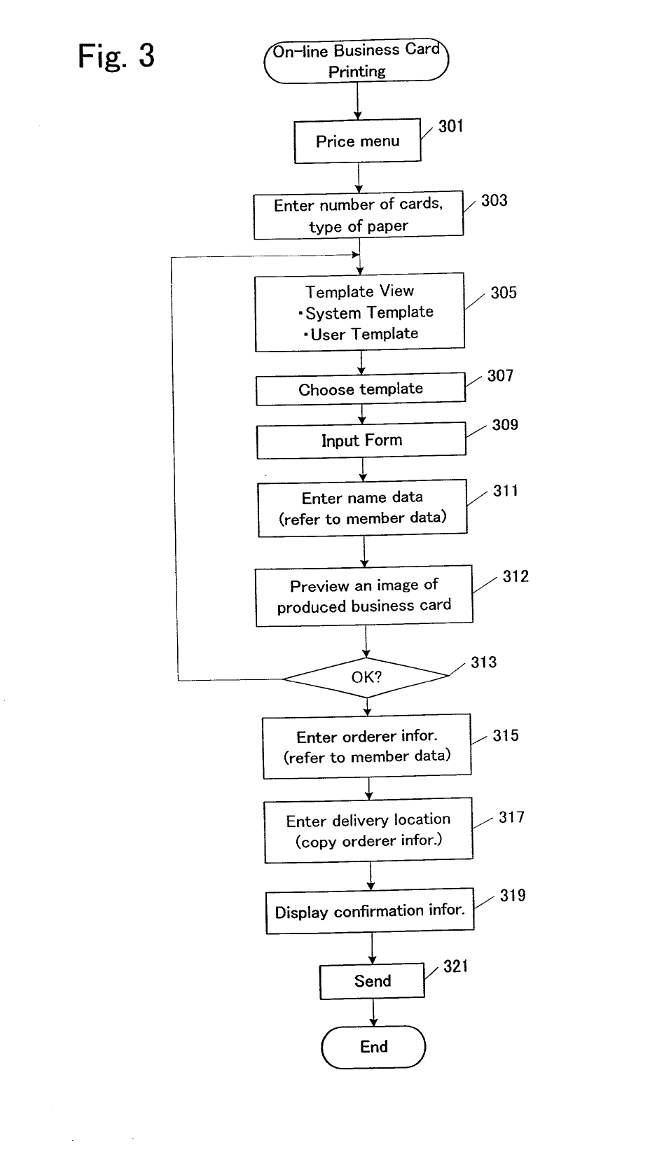

A member can log in to the member page from the top page (FIG. 2) of the web site and enter a page for on-line business card printing. FIG. 3 is a flow chart showing a flow of a process for on-line business card printing. When the member enters the page for on-line business card printing, a menu of printing prices is shown first (301). In the menu, a plurality of prices are prepared according to grades of business card paper, color printing or monochromatic printing, and a number of pieces to be printed. The user selects a desired one out of them and clicks it. For example, a price menu takes a form as shown in the following table. It should be noted that the price is shown in terms of Japanese yen.

TABLE 3

| | Monochromatic | | | | Color | | | |
|---|---|---|---|---|---|---|---|---|
| | One side | | Both sides | | One side | | Both sides | |
| | 50 | 100 | 50 | 100 | 50 | 100 | 50 | 100 |
| Paper | pcs | pcs | pcs | pcs | pcs | pcs | pcs | pcs |
| Recycled | 750 | 950 | 1100 | 1250 | 990 | 1250 | 1400 | 1800 |
| paper A | | | | | | | | |
| Recycled | 750 | 950 | 1100 | 1250 | 990 | 1250 | 1400 | 1800 |
| paper B | | | | | | | | |
| Prince | 700 | 900 | 990 | 1200 | 950 | 1200 | 1300 | 1700 |
| White | 700 | 900 | 990 | 1200 | 950 | 1200 | 1300 | 1700 |

A price indicated in the price list displayed on the browser is linked to a template selection page. When the user selects one from the table and clicks it, the information is transmitted to the web server, and the content selected by the user is stored in the on-line business card production program section 13E (FIG. 1) (303). The web server, in response to this, transmits a template selection page to the user via the Internet (305).

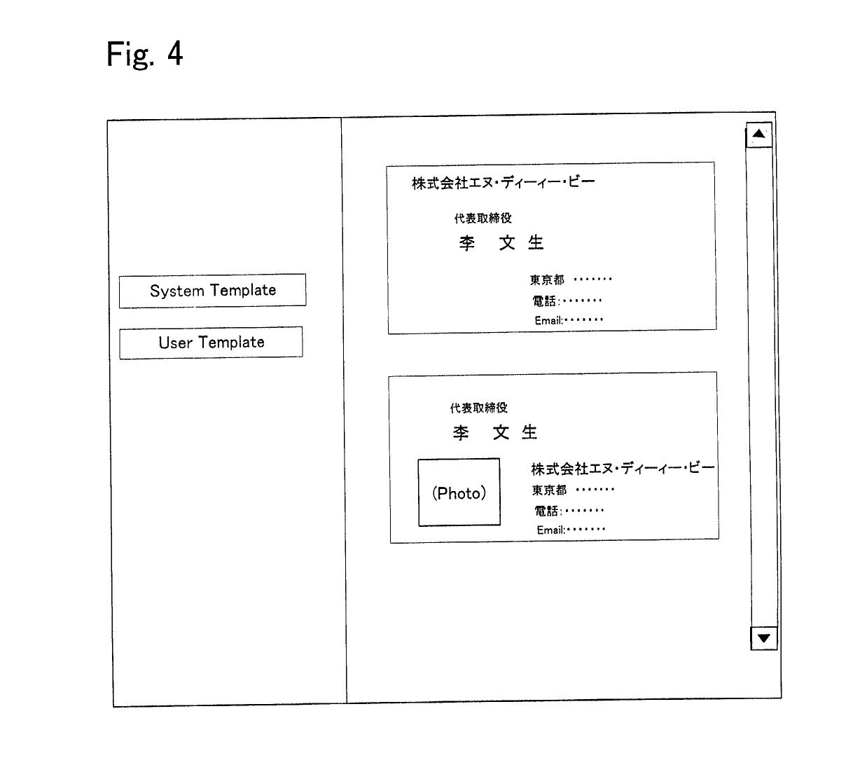

FIG. 4 shows an example of this template selection page. There are two kinds of templates, namely a system template prepared by the system and a user template prepared by a user using a template preparation page in advance and stored in the system. When a button of the system template is clicked, a plurality of templates prepared by the system is displayed on the screen. Ten to twenty templates are prepared with different arrangement of such items as name, place of employment, address, facial portrait and the like, which can be displayed on the screen by scrolling. In this way, when a template with a desired layout is determined by clicking the template (307), determination information is sent to the on-line business card production program section 13E via the Internet. In response to this, the business card production program section 13E transmits a business card input form to the user (309).

The business card input form includes input fields for items shown in the following table. When the user enters an ND_ID that is its own name data ID in an input field of My ID and clicks a transmission button, this information is transmitted to the business card production program section 13E. In response to this, the business card production program section 13E searches the database, inserts data relating to the identification code into corresponding fields of the business card input form, and send it to the user. Thus, user data is inserted and displayed on the browser. The user can change contents of items to be printed on a business card by overwriting the input fields on the screen (311).

A user who is not a member of this system can enter items to be printed on a business card by entering data in each field of the input form utilizing a word processor.

Table 4

ND_ID

Name

Place of employment

Title

ZIP code

Address 1

Address 2

Telephone number

Facsimile number

E-mail address

In this way, when necessary items for printing a business card have been entered and a preview button (not shown) in the lower part of the input form is clicked, an image of a business card to be printed is displayed as it is (312). If there is any item that requires correction in the contents, layout or the like, the user may return to the preparation page to make a correction. If there is no item to be corrected, the user clicks the transmission button. In response to this, the information is transmitted to the web server 13, and the business card producing section 13E transmits to the user a form for entering information on an orderer and delivery destination of business cards (315, 317). This form includes input fields that are essentially similar to the input fields shown in Table 4, and is configured so that information on an orderer and a delivery destination of business cards can be entered. If a corporation places an order for printing business cards for an employee, the orderer is the corporation and the delivery destination may be a general affairs department of the corporation or a section to which the employee belongs. If the delivery destination is the same as the orderer, input in the delivery destination field can be omitted (317).

When these items are entered and the transmission button provided in the input form is clicked, the entered information is transmitted to the web server 13. Then, the on-line business card production program section 13E transmits a confirmation page to display the entered items to the user (319). When the user confirms the items on this confirmation page and clicks a confirmation button provided on the confirmation page, the event is transmitted to the web server 13. Then, the on-line business card print program 13E, in response to this, sends data to a printer connected to the system and causes the printer to start printing business cards. Printing of business cards is not required to be started immediately after receiving an order, but is preferably carried out on a selected time when load to the system is light.

FIG. 5 shows a page for on-line business card printing in another embodiment of the invention. When a user selects template in a template selection field and clicks a GO button, the on-line business card production section 13E responds by transmitting a selected template 45 to the user. If the user is a member of the system, the on-line business card producing section 13E searches the member database 15A with an ID used by the member for logging in, and retrieves name data on the member to insert it into the template.

Therefore, all the data required for producing a business card is already written in the template 45 to be displayed on a browser of the member. When an “edit” button attached to each item of the template 45 is clicked, a form for specifying style of characters, font and color is transmitted to the browser from the web server. When the member enters data in this form and transmits it, a page showing the result is transmitted from the server to the browser. An image 45e such as a design, a photograph or the like can be uploaded from the client side.

When the type of paper for printing a business card is selected in a field for selecting paper 46, the number of cards to be printed can be entered in a field 47. When a GO button or an order confirmation button 49 is clicked, the contents of a business card are transmitted to the web server 13. The design of a business card confirmed in this way is stored in the business card production database 15C and is referred to when a next order is placed. A corporation running the name data system on the web server 13 may carry out printing and delivery of the business cards in accordance with the orders. Alternatively, it may have a printing company print the business cards and deliver them directly to a member. Thus, a business card can be produced using the content stored in the name database 15A.

Utilization Program

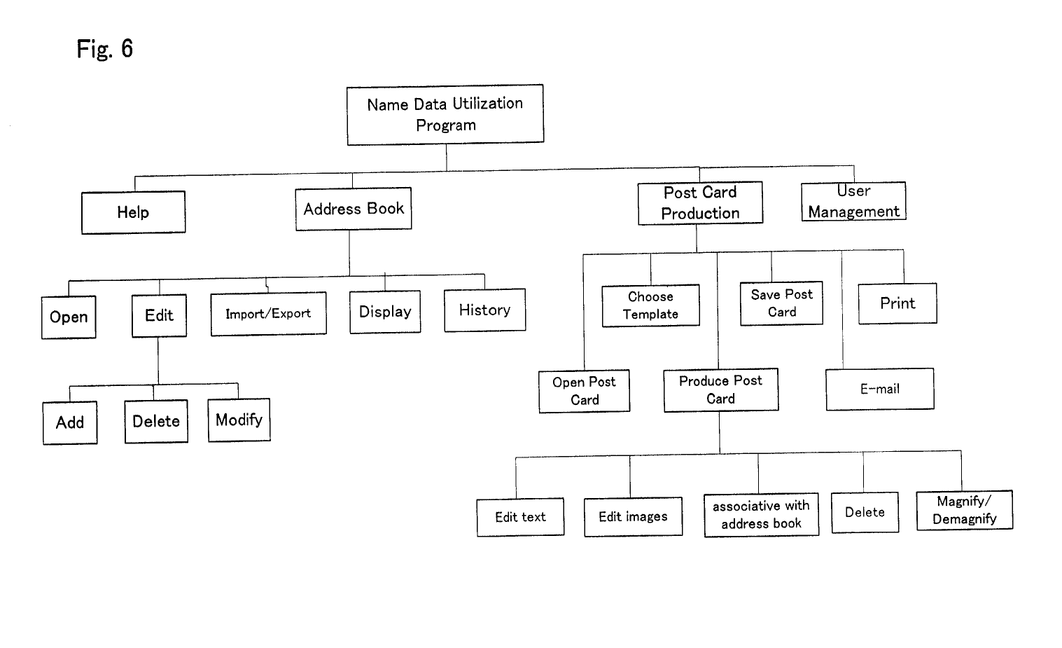

A user can download a data utilization program for making use of data on a member by clicking the button 25 on the top page (FIG. 2) of the web site of the system. As shown in FIG. 6, the data utilization program has a function of making use of downloaded name data in a manner of an address book, and a function of producing a post card. Similarly, the data utilization program may have a function of producing a greeting card. A greeting card is similar to a postcard except that the greeting card has no specific limitation on its size.

Since an address book stores data in the CSV format, data can be imported from or exported to in the CSV format a spreadsheet program such as Excel (trademark) of Microsoft Corporation and a database program such as Access (trademark) of Microsoft Corporation.

A basic configuration of the address book used in this embodiment may be the same as the address book provided in the e-mail function of Internet Explorer (trademark) of Microsoft Corporation. The address book preferably includes fields for recording family information, telephone number, facsimile number, date of birth, place of employment information, link to photograph file, comment and the like in order to store detailed information on individuals.

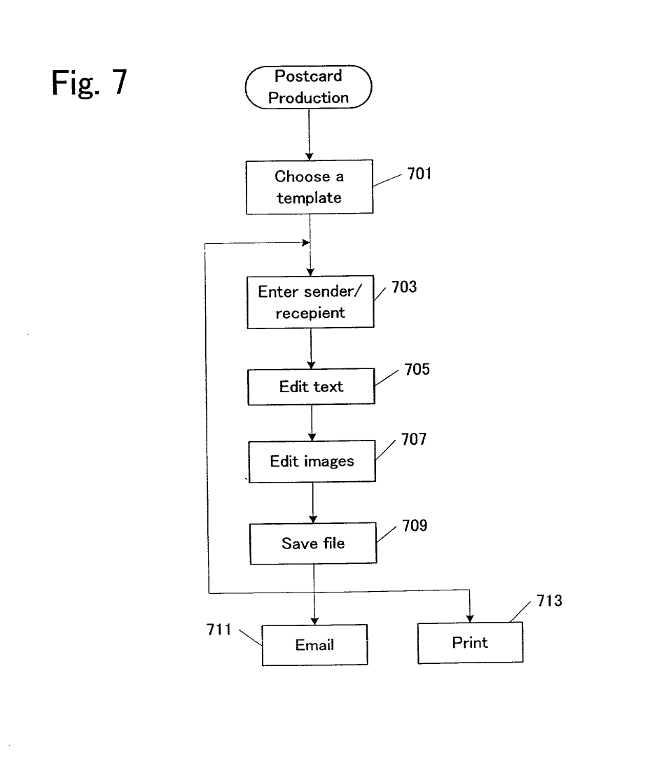

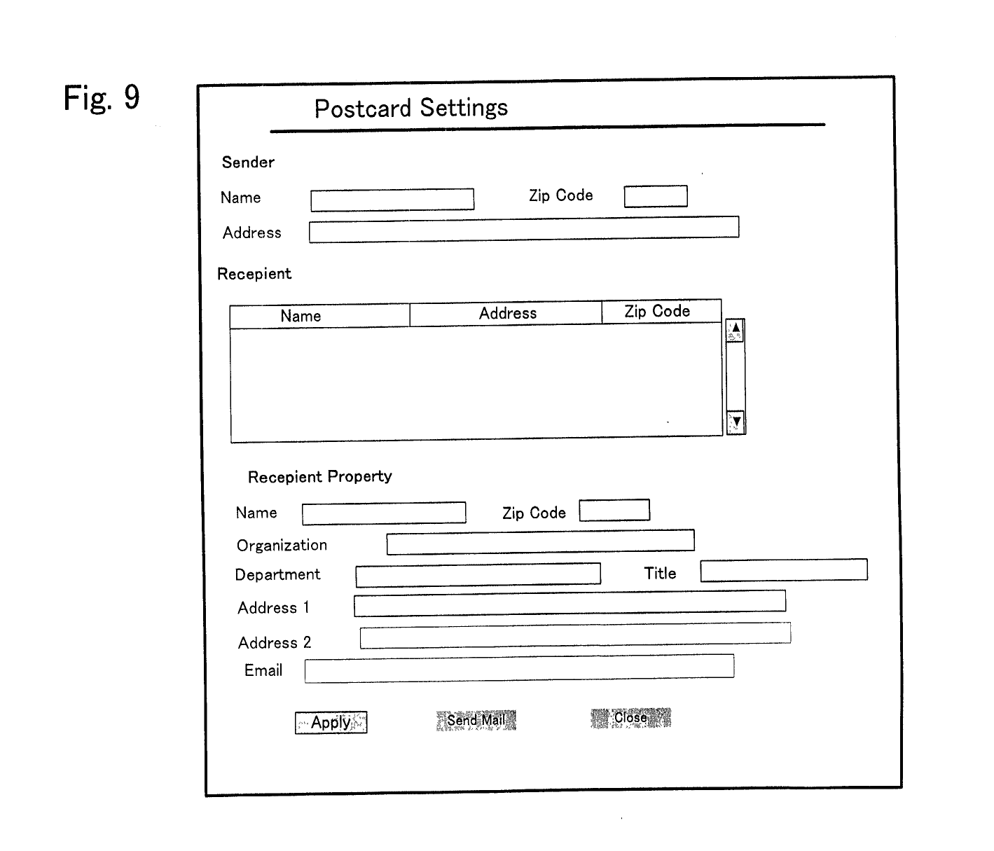

FIG. 7 is a flow chart of a function of producing a postcard or a card of other kinds, which is included in the data utilization program. When a user selects “postcard production” from the menu of the data utilization program, an initial page for producing a post card or a card of other kinds is displayed on the screen. When the user clicks an icon for selecting a template, a template of design of a postcard or a card of other kinds is displayed (701). This template has the same structure as the template for producing a business card shown in FIG. 4, and provides a plurality of background designs of a postcard or a card of other kinds instead of the business card of FIG. 4. When a user clicks one of the displayed templates, an editing box of destination and sender of a postcard shown in FIG. 9 is displayed on the screen. When an icon for selecting a destination and a sender is clicked from a menu bar displayed on this screen, a page for setting business card data is displayed.

In the field for a sender, the name and address of the user stored in advance are displayed. When a user desires to modify the displayed name or address, it can write directly in the name or address field with a word processor. In a recipient field, a list of all the people for the business card data included in the address book may be displayed with scrolling function. When the user selects from the list a person to whom a postcard is to be sent and clicks the name, data on the selected person is displayed in the name field, address field, organization name field and e-mail field of the recipient.

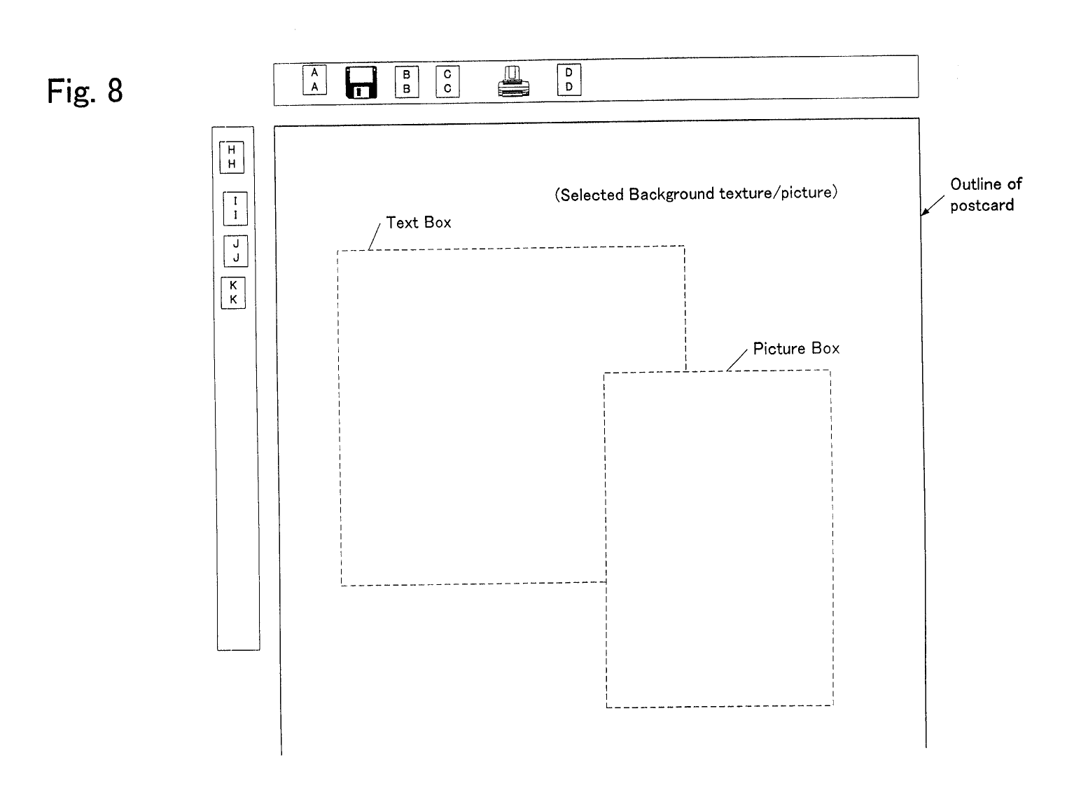

When the user finishes writing the destination data in the input form (703) and clicks a “next” button in the lower part of this form, a page linked to the button for editing a message part of a post card is displayed as shown in FIG. 8 (705, 707). This editing page includes a text box for writing text and a picture box for inserting an image.

The user can write a message in the text box using a word processing function of a personal computer in use. In addition, the user can paste in the picture box a file of photograph or other images stored in the personal computer in use. In this way, the user finishes editing the message part of the postcard.

When the user finishes editing the message part and clicks the “next” button in the lower part of the page, a confirmation page showing a sender, a destination and the overall view of the postcard is displayed. When a “send by mail” button in the lower part of this confirmation page is clicked, the produced postcard or card of other kinds is transmitted to the destination as a text of an electronic mail in the form of an HTML file in which its front side and back side are arranged horizontally or vertically in one plane. When an “application” button in the lower part of the confirmation page is clicked, data on the destination and the sender is written in the back side of the postcard, and is stored in a folder in the personal computer that is specified in advance. The user can output the produced postcard or card of other kinds to a printer in this way. In the case of a postcard, the user can put a stamp on it and mail it to the destination.

Instead of the procedures described above, it is also possible to edit a message part of a postcard or a card of other kinds first, and then set a sender and a destination. In this case, an “application” button and a “mail transmission” button shown in the lower part of the page of FIG. 9 performs the same function as the “application” button and the “mail transmission” button of the above-mentioned confirmation page.

Although the invention has been described in detail with respect to specific embodiments thereof, it is not intended to be limited thereto. This invention is limited only by the appended claims.

What is claimed is:

1. A system for managing information having a member database for storing identification codes for a plurality of members and information on respective members, and a web server associated with the member database, said web server being programmed to:
transmit to a user, in response to access from the user via the Internet, an HTML document that has an input field for said identification code,
responsive to receipt of said identification code from the user, search the member database using said identification code as a key to retrieve information on a member corresponding to said identification code, and
transmit said information to the user.

2. The system for managing information according to claim 1, wherein said web server includes a database program for use by a user with a user computer, said web server being further programmed to:
transmit to a user, in response to access of the user, an HTML document including a button or an input field for requesting downloading of said database program, and
transmit the database program to the user responsive to receipt of a request from the user.

3. The system for managing information according to claim 1, wherein said web server includes a database for producing business cards, and is programmed to:
transmit to a user, in response to access from a user, an HTML document carrying a page that includes a template and an input field for producing business cards, and
accept orders for printing business cards, with data on a member being read out from the member database.

4. The system for managing information according to claim 1, wherein said web server comprises recording means for recording an e-mail address of a user who has downloaded information on a member, said web server being programmed to:
refer to said recording means when a change is made to data on the member, and
transmit information on such change by e-mail to the user who has downloaded the data on the member.

5. A computer executable program adapted for use by a user in conjunction with a system having a member database for storing identification codes for a plurality of members and information on respective members, and a web server associated with said member database, said web server being configured to search said member database in response to a user access via the Internet to retrieve information on a member and transmit said information to a user, said computer executable program having the functions of:
storing in an address book said information on the member downloaded from said web server,
displaying on a screen of a computer an input page having a text block for producing a message part of a card and a picture block for pasting an image, and
setting a destination of the card based on data contained in said address book.

6. The program according to claim 5, wherein said computer executable program is transmitted from said web server to a user in response to a user request.

7. The program according to claim 6, wherein said program is configured so that name and address data in the CSV format can be imported or exported.

8. The program according to claim 5, wherein the program further has a function of transmitting said card to a destination by e-mail by clicking a transmission button.
